(19) United States
(12) Patent Application Publication
(10) Pub. No.: US 2013/0086913 A1
(43) Pub. Date: Apr. 11, 2013

(54) TURBOMACHINE COMBUSTOR ASSEMBLY INCLUDING A COMBUSTION DYNAMICS MITIGATION SYSTEM

(71) Applicants: Mahesh Bathina, Ongole (IN); Madanmohan Manoharan, Chennai (IN)

(72) Inventors: Mahesh Bathina, Ongole (IN); Madanmohan Manoharan, Chennai (IN)

(73) Assignee: GENERAL ELECTRIC COMPANY, Schenectady, NY (US)

(21) Appl. No.: 13/269,090

(22) Filed: Oct. 7, 2011

(51) Int. Cl. F02C 7/22

(52) U.S. Cl. 60/746

(57) ABSTRACT

A turbomachine combustor includes a combustor cap having a cap surface and a wall that extends about the cap surface to define a cap volume, and a plurality of nozzle members that extend from the cap surface. The plurality of nozzle members include a center nozzle member and one ore more outer nozzle members. A combustor dynamics mitigation system is arranged in the combustor cap and includes plurality of divider members that extend from the wall toward the center nozzle member. The plurality of divider members define a plurality of parallel resonator volumes. The combustor dynamics mitigation system also includes a plurality of tubes that extend into corresponding ones of the plurality of parallel resonator volumes.

### BACKGROUND OF THE INVENTION

The subject matter disclosed herein relates to the art of turbomachines and, more particularly, to a turbomachine combustor assembly including a combustor dynamics mitigation system.

As requirements for gas turbine emissions have become more stringent, one approach to meeting such requirements is to move from conventional diffusion flame combustors to combustors utilizing lean fuel/air mixtures during fully premixed operation to reduce emissions of, for example, NOₓ and CO. These combustors are known in the art as Dry Low NOₓ (DLN), Dry Low Emissions (DLE) or Lean Pre Mixed (LPM) combustion systems. Such combustors typically include multiple fuel nozzles housed in a barrel, also known as a cap cavity.

Because these combustors operate at such lean fuel/air ratios, small changes in velocity can result in large changes in mass flow that may lead to fuel/air fluctuations. These fluctuations may result in a large variation in the rate of heat release as well as create high pressure fluctuations in the cap cavity. Interaction of fuel/air fluctuation, vortex-flame interaction, and unsteady heat release may lead to a feed back loop mechanism resulting in dynamic pressure pulsations in the combustion system. The phenomenon of pressure pulsations is referred to as thermo-acoustic or combustion-dynamic instability, or simply, combustion dynamics. High levels of combustion dynamics limit the operational envelope of the combustor by imposing limitations on emission reduction and power output. Further, the presence of combustion dynamics shortens hardware life. More specifically, combustion dynamics may cause damage to combustor components that would require repair. Repairing combustor components requires that the turbomachine be taken offline. Thus in addition to costs associated with repairing the combustor components, additional costs are realized through lost turbomachine operation time.

### BRIEF DESCRIPTION OF THE INVENTION

According to one aspect of the exemplary embodiment, a turbomachine combustor includes a combustor cap having a cap surface and a wall that extends about the cap surface to define a cap volume, and a plurality of nozzle members that extend from the cap surface. The plurality of nozzle members include a center nozzle member and one or more outer nozzle members. A combustor dynamics mitigation system is arranged in the combustor cap and includes plurality of divider members that extend from the wall toward the center nozzle member. The plurality of divider members define a plurality of parallel resonator volumes. The combustor dynamics mitigation system also includes a plurality of tubes that extend into corresponding ones of the plurality of parallel resonator volumes.

According to another aspect of the exemplary embodiment, a gas turbomachine includes a compressor portion, a turbine portion operatively connected to the compressor portion, and a combustor assembly fluidly connected to the compressor portion and the turbine portion. The combustor assembly includes a combustor cap having a cap surface and a wall that extends about the cap surface to define a cap volume. A plurality of nozzle members extend from the cap surface. The plurality of nozzle members include a center nozzle member and one or more outer nozzle members. A plurality of divider members extend from wall toward the center nozzle member. The plurality of divider members define a plurality of parallel resonator volumes. A plurality of tubes extend into corresponding ones of the plurality of parallel resonator volumes.

According to yet another aspect of the exemplary embodiment, a method of mitigating combustor dynamics in a turbomachine combustor assembly includes passing a fluid flow into a combustor cap of the combustor assembly, diverting a portion of the fluid flow into a plurality of parallel resonator volumes arranged within a cap volume of the combustor cap, and generating at least one frequency in each of the parallel resonator volumes that is configured and disposed to tune out a natural frequency of the combustor assembly to mitigate combustor dynamics.

These and other advantages and features will become more apparent from the following description taken in conjunction with the drawings.

### BRIEF DESCRIPTION OF THE DRAWING

The subject matter, which is regarded as the invention, is particularly pointed out and distinctly claimed in the claims at the conclusion of the specification. The foregoing and other features, and advantages of the invention are apparent from the following detailed description taken in conjunction with the accompanying drawings in which:

FIG. 1 is a schematic view of a gas turbomachine system including a combustor assembly having a combustion dynamics mitigation system in accordance with an exemplary embodiment;

FIG. 2 is a perspective view of a combustor cap of the combustor assembly of FIG. 1;

FIG. 3 is a partial cross-sectional view of the combustor cap of FIG. 2;

FIG. 4 is a partial perspective view of a combustor cap in accordance with another aspect of the exemplary embodiment;

FIG. 5 is a partial cross-sectional view of the combustor cap of FIG. 4; and

FIG. 6 is a plan view of a combustor cap in accordance with another aspect of the exemplary embodiment.

The detailed description explains embodiments of the invention, together with advantages and features, by way of example with reference to the drawings.

### DETAILED DESCRIPTION OF THE INVENTION

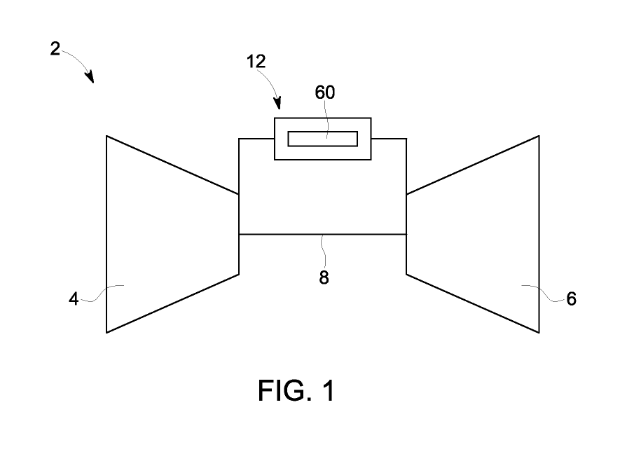

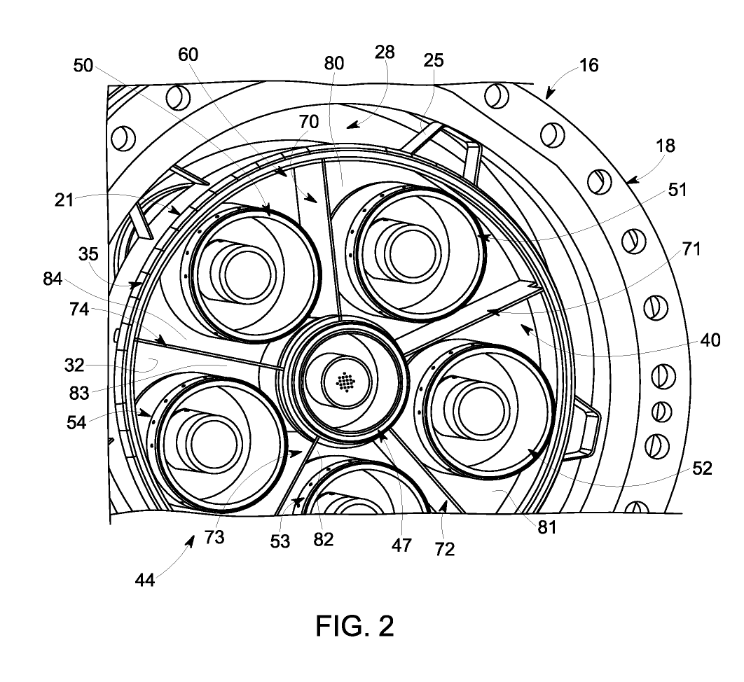

With reference to FIGS. 1-2 a gas turbomachine in accordance with an exemplary embodiment is indicated generally at 2. Gas turbomachine 2 includes a compressor portion 4 operatively connected to a turbine portion 6 through a common compressor/turbine shaft 8. Compressor portion 4 is also fluidly connected to turbine portion 6 via a plurality of can-annular combustor assembles one of which is indicated at 12. In the exemplary embodiment shown, combustor assembly 12 includes a combustor cap 16 having a main body 18 that supports an injection nozzle assembly 21. Injection nozzle assembly 21 is spaced from main body 18 by a plurality of support members, one of which is indicted at 25, so as to define a fluid flow path 28.

Injection nozzle assembly 21 includes a back plate or cap surface 32 that is surrounded by a wall 35 to collectively define a cap volume 40. Injection nozzle assembly 21 also includes a plurality of nozzle members 44 that extend from cap surface 32. The plurality of nozzle members 44 include a center nozzle member 47 and a plurality of outer nozzle members 50-54 that area arrayed about center nozzle member 47. In accordance with the exemplary embodiment, injection nozzle assembly 21 includes a combustor dynamics mitigation system 60 that is configured to reduce and/or eliminate combustion dynamics in combustor assembly 12.

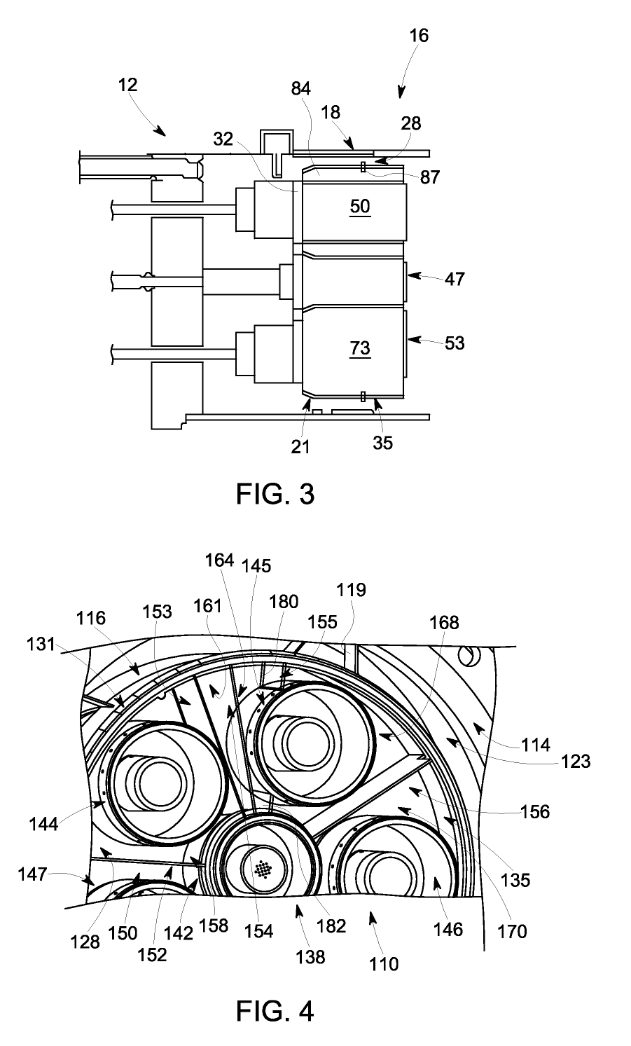

In accordance with the exemplary embodiment, combustor dynamics mitigation system 60 includes a plurality of divider members 70-74 that extend through cap volume 40. More specifically, divider members 70-74 extend from center nozzle member 47 to wall 35 between adjacent ones of outer nozzle members 50-50 so as to define a plurality of parallel resonator volumes 80-84. Each resonator volume 80-84 is fluidly coupled to fluid flow path 28 via a corresponding plurality of tubes, one of which is indicated at 87 in FIG. 3. As will be discussed more fully below, tubes 87 deliver a fluid flow into respective ones of parallel resonator volumes 80-84 to produce a frequency that cancels out a natural frequency of combustor assembly 12 in order to reduce and/or eliminate combustion dynamics

In accordance with an exemplary embodiment, fluid, typically in the form of compressed air from compressor portion 4 flows through fluid flow path 28 toward a head end (not shown) of combustor cap 16. The compressed air mixes with fuel and passes through injection nozzles (not separately labeled) to be combusted in combustor assembly 12. Fluctuations in the fuel and air flow, vortex-flame interactions, and unsteady heat release all lead dynamic pressure pulsations in the combustion system. The dynamic pressure pulsations have a natural frequency that is substantially canceled by introducing air from the fluid flow path into each of the plurality of parallel resonator volumes 80-84.

Parallel resonator volumes 80-84 together with the tubes 87 act as an acoustic damper. Acoustic pressure and velocity at tubes location is altered resulting in an overall system acoustic change. Each parallel resonator volume 80-84 connected to fluid flow path 28 is sized so as to resonate at a frequency (f) which is determined by a cross-sectional area (S) of each tube 87, a length (L) of each tube 87, and a volume (V) of each of the plurality of parallel resonator volumes 80-84. The frequency is given by equation:

f=(c/(2*π))*sqrt(S/(V*L))

where “c” is the speed of sound. A desired frequency can be achieved by changing a volume of one or more of the plurality of parallel resonator volumes 80-84. To mitigate a natural frequency of the combustor assembly 12, a matching frequency is chosen, and the characteristics of V, L, and S are set to attain the desired frequency. To achieve the desired L, one or more of tubes 87 may extend into a respective one of the plurality of parallel resonator volumes 80-84. During operation of combustor assembly 12, the chosen frequency effectively “tunes out” the natural frequency created by the dynamic pressure pulsations thereby preventing and/or substantially eliminating issues associated with the occurrence of combustion dynamics.

Reference will now be made to FIG. 4 in describing a combustor cap 110 in accordance with another exemplary embodiment. Combustor cap 110 includes a main body 114 that supports an injection nozzle assembly 116. Injection nozzle assembly 116 is spaced from main body 114 by a plurality of support members, one of which is indicted at 119, so as to define a fluid flow path 123. Injection nozzle assembly 116 includes a back plate or cap surface 128 that is surrounded by a wall 131 to collectively define a cap volume 135. Injection nozzle assembly 116 also includes a plurality of nozzle members 138 that extend from cap surface 128. The plurality of nozzle members 138 include a center nozzle member 142 and a plurality of outer nozzle members, four of which are indicted at 144-147 that are arrayed about center nozzle member 142. In accordance with the exemplary embodiment, injection nozzle assembly 116 includes a combustor dynamics mitigation system 150 that is configured to reduce and/or eliminate combustion dynamics in combustor assembly 12.

In accordance with the exemplary embodiment, combustor dynamics mitigation system 150 includes a plurality of divider members 152-156 that extend through cap volume 135. More specifically, divider members 152-156 extend from center nozzle member 142 to wall 131 so as to define a plurality of parallel resonator volumes 158, 161, 164, 168, and 170. In the exemplary embodiment shown, parallel resonator volumes 158, 161, 164, 168, and 170 are distinct one from another. That is, each parallel resonator volume 158, 161, 164, 168, and 170 has a different volume size based on the particular location of each divider member 152-156 as will be discussed more fully below.

Different volume sizes are achieved by arranging multiple divider members such as divider 153 and divider 154 between adjacent outer nozzle members 144 and 145. Volume size is also affected by interrupting a divider member with an outer nozzle member. That is, divider member 155 includes a first portion 180 that extends between wall 131 and outer nozzle member 145 and a second portion 182 that extends between outer nozzle member 145 and center nozzle member 142. Adjusting volume size allows for greater flexibility in controlling combustion dynamics. In addition, by creating parallel resonator volumes having different sizes, combustion dynamics mitigation system 150 may “tune-out” multiple natural frequencies produced by combustor assembly 12.

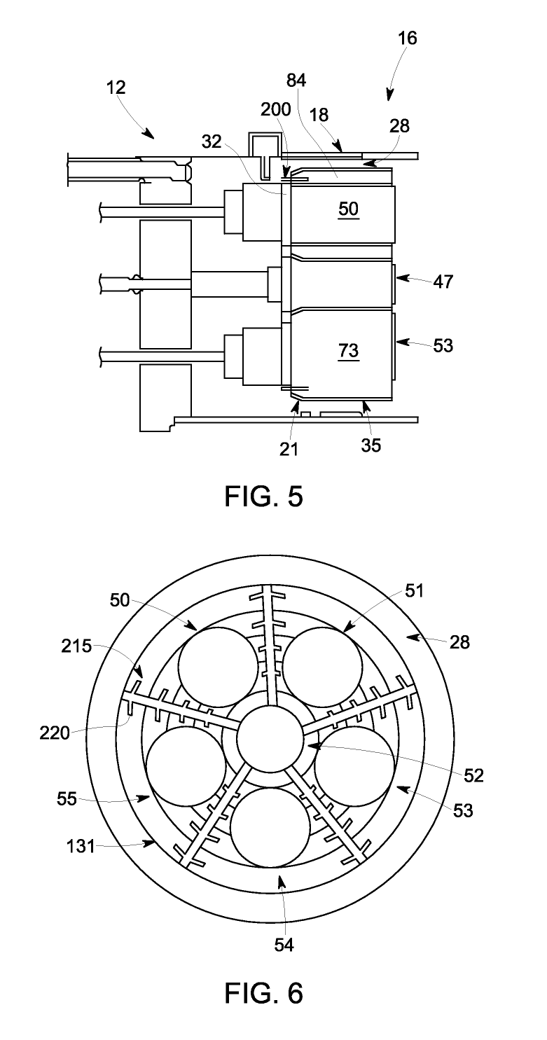

At this point it should be understood that the exemplary embodiments describe a system for mitigating combustion dynamics in a gas turbomachine combustor assembly. The combustor assembly includes a combustor cap having arranged therein a plurality of parallel resonator volumes that are fluidly connected to compressor air flow. The plurality of parallel resonator volumes along with tubes that fluidly connect each parallel resonator volume with the compressor flow are sized so as to “tune-out” combustion dynamics produced by dynamic pressure pulsations in the combustor assembly. Thus, it should be appreciated that the number, size, and arrangement of parallel resonator volumes can vary. It should also be understood that the location of tubes that provide compressor air to the resonator volumes can vary. For example, as shown in FIG. 5, wherein like reference numbers represent corresponding parts in the respective views, a tube 200 is shown extending through cap surface 32. FIG. 6, wherein like reference numbers represent corresponding parts in the respective views, illustrates a number of plenums, one of which is indicated at 215, that deliver compressor air into each parallel resonator volume. Plenum 215 extends from cap wall 131 to center nozzle 52 and includes a plurality of conduits, one of which is shown at 220, that deliver compressor air into corresponding parallel resonator volumes.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. A turbomachine combustor comprising:
a combustor cap including a cap surface and a wall that extends about the cap surface to define a cap volume;
a plurality of nozzle members extending from the cap surface, the plurality of nozzle members including a center nozzle member and one or more outer nozzle members; and
a combustor dynamics mitigation system arranged in the combustor cap, the combustor dynamics mitigation system including:
a plurality of divider members extending from wall toward the center nozzle member, the plurality of divider members defining a plurality of parallel resonator volumes; and
a plurality of tubes extending into corresponding ones of the plurality of parallel resonator volumes.

2. The turbomachine combustor according to claim 1, wherein the one or more nozzle members includes at least two adjacent nozzle members, one of the plurality of divider members extends between the at least two adjacent nozzle members.

3. The turbomachine combustor according to claim 1, wherein at least one of the plurality of divider members intersects one of the one or more nozzle members.

4. The turbomachine combustor according to claim 1, wherein the one or more nozzle members includes at least two adjacent nozzle members, at least two of the plurality of divider members extend between the at least two adjacent nozzle members.

5. The turbomachine combustor according to claim 1, wherein each of the plurality of parallel resonator volumes is substantially identical.

6. The turbomachine combustor according to claim 1, wherein at least one of the plurality of parallel resonator volumes includes a size that is distinct from a size of others of the plurality of resonator volumes.

7. The turbomachine combustor according to claim 1, a fluid flow path extending about the wall, the fluid flow path being configured and disposed to deliver a fluid flow into each of the plurality of parallel resonator volumes.

8. The turbomachine combustor according to claim 1, wherein the plurality of parallel resonator volumes are sized to create a particular frequency that is configured and disposed to mitigate a predetermined natural frequency of the combustor.

9. The turbomachine combustor according to claim 1, wherein each of the plurality of parallel resonator volumes are sized to create particular frequencies that are configured and disposed to mitigate a plurality of natural frequencies of the combustor.

10. The turbomachine according to claim 1, wherein each of the plurality of tubes extend through the cap surface.

11. The turbomachine according to claim 1, further comprising: a plurality of plenums that are configured and disposed to deliver compressor air to each of the plurality of parallel resonator volumes, each of the plurality of plenums extending from the wall to the center nozzle member and including one or more conduits that fluidly connect to at least one of the plurality or parallel resonator volumes.

12. A gas turbomachine comprising:
a compressor portion;
a turbine portion operatively connected to the compressor portion; and
a combustor assembly fluidly connected to the compressor portion and the turbine portion, the combustor assembly including:
a combustor cap including a cap surface and a wall that extends about the cap surface to define a cap volume; and
a plurality of nozzle members extending from the cap surface, the plurality of nozzle members including a center nozzle member and one or more outer nozzle members; and
a combustor dynamics mitigation system arranged in the combustor cap, the combustor dynamics mitigation system including:
a plurality of divider members extending from the wall toward the center nozzle member, the plurality of divider members defining a plurality of parallel resonator volumes; and
a plurality of tubes extending into corresponding ones of the plurality of parallel resonator volumes.

13. The gas turbomachine according to claim 12, wherein the one or more nozzle members includes at least two adjacent nozzle members, one of the plurality of divider members extending between the at least two adjacent nozzle members.

14. The gas turbomachine according to claim 12, wherein at least one of the plurality of divider members intersects one of the one or more nozzle members.

15. The gas turbomachine according to claim 12, wherein the one or more nozzle members includes at least two adjacent nozzle members, at least two of the plurality of divider members extending between the at least two adjacent nozzle members.

16. The gas turbomachine according to claim 12, wherein each of the plurality of parallel resonator volumes is substantially identical.

17. The gas turbomachine according to claim 12, wherein at least one of the plurality of parallel resonator volumes includes a size that is distinct from a size of others of the plurality of resonator volumes.

18. The gas turbomachine according to claim 12, further comprising: a fluid flow path extending about the wall, the fluid flow path being configured and disposed to deliver a fluid flow into each of the plurality of parallel resonator volumes.

19. The gas turbomachine according to claim 12, wherein the plurality of parallel resonator volumes are sized to create a particular frequency that is configured and disposed to mitigate a predetermined natural frequency of the combustor.

20. The gas turbomachine according to claim 12, wherein each of the plurality of parallel resonator volumes are fixed to create particular frequencies that are configured and disposed to mitigate a plurality of natural frequencies of the combustor.
